(19) United States
(12) Patent Application Publication
(10) Pub. No.: US 2007/0165209 A1
(43) Pub. Date: Jul. 19, 2007

(54) Nanoparticles As Covert Taggants In Currency, Bank Notes, And Related Documents

(75) Inventors: Michael J. Natan, Los Altos, CA (US); Scott Norton, Durham, NC (US); R. Griffith Freeman, Mountain View, CA (US); Sharron Gaynor Penn, San Carlos, CA (US); Ian Walton, Redwood City, CA (US)

Correspondence Address: SWANSON & BRATSCHUN L.L.C., 1745 SHEA CENTER DRIVE, SUITE 330, HIGHLANDS RANCH, CO, 80129, US

(73) Assignee: OXONICA, INC., Mountain View, CA (US)

(21) Appl. No.: 11/674,597

(22) Filed: Feb. 13, 2007

Related U.S. Application Data
(63) Continuation of application No. 11/198,870, filed on Aug. 5, 2005, now abandoned.
(63) Continuation-in-part of application No. 11/132,974, filed on May 18, 2005.
Application No. 11/132,974 is a continuation of application No. 10/345,821, filed on Jan. 16, 2003, now Pat. No. 7,192,778.
Application No. 11/132,974 is a continuation-in-part of application No. 10/345,821, filed on Jan. 16, 2003, now Pat. No. 7,192,778.
(60) Provisional application No. 60/599,115, filed on Aug. 5, 2004.
(60) Provisional application No. 60/636,242, filed on Dec. 14, 2004.

(51) Int. Cl. B05D 1/12; G01J 3/44; G06K 9/74

(52) U.S. Cl. 356/71; 427/180; 356/301

(57) ABSTRACT

Methods for applying security tags and/or data to currency and other documents and systems for use are provided.

### CROSS-REFERENCE TO RELATED APPLICATIONS

This application is a continuation of U.S. patent application Ser. No. 11/198,870, filed Aug. 5, 2005, entitled “Nanoparticles As Covert Taggants In Currency, Bank Notes, And Related Documents,” which is a nonprovisional of U.S. Provisional Patent Application Ser. No. 60/599,115, filed Aug. 5, 2004, entitled “Passive SERS-Based Tagging” and of U.S. Provisional Patent Application Ser. No. 60/636,242, filed Dec. 14, 2004, entitled “Nanoparticles as Covert Taggants in Currency, Bank Notes, and Related Documents.” This application also is a continuation in part of U.S. patent application Ser. No. 11/132,974, filed May 18, 2005, entitled “Surface Enhanced Spectroscopy-Active Composite Nanoparticles” which is a continuation of U.S. patent application Ser. No. 10/345,821, filed Jan. 16, 2003, entitled “Surface Enhanced Spectroscopy-Active Composite Nanoparticles”. This application also is a continuation in part of U.S. patent application Ser. No. 10/345,821, filed Jan. 16, 2003, entitled “Surface Enhanced Spectroscopy-Active Composite Nanoparticles”.

### FIELD OF THE INVENTION

The present invention concerns methods for applying security tags and/or data to currency and other documents and systems for their use.

### BACKGROUND OF THE INVENTION

Counterfeiting has been called “the crime of the 21st century.” The numbers detailing lost trade and jobs, while varying widely from report to report, are all staggeringly large. Some targets of counterfeiters are currency, checks and financial documents. In 1998, £6.1 million were seized in the UK, the majority in £20 notes, and over 95% of which was counterfeited by lithographic printing. This is probably the tip of the iceberg, since this amount could be printed in a matter of days at the printing rates available with litho presses. The US Bureau of Engraving and Printing uses many overt security features on currency since the routine authentication of banknotes is best accomplished by the general public. However, there are also forensic features that are used by the Secret Service, indicating a potential market for novel tagging technologies.

The use of Raman and resonance Raman scattering spectroscopy has been described as a detection method for use with inks containing Raman active compounds as a constituent; for example polydiacetylenes (U.S. Pat. No. 5,324,567). Various Raman-active inks have been described; for example an ink which contains a SERS-active metal aggregate containing a Raman active compound (U.S. Pat. No. 5,853,464); and a pigment having adsorbed on its surface a coding compound which is a compound containing an azo, azomethine or polycyclic chromophore and which has a Raman spectrum (U.S. Pat. No. 5,718,754).

### SUMMARY OF THE INVENTION

The present invention provides a method for generating a security feature for documents, the method comprising providing a document to be protected and applying a SENSER tag to at least a first portion of the document. The SENSER tag comprises a metal nanoparticle, a Raman-active molecule associated with the surface of the metal nanoparticle, and an encapsulant surrounding said metal nanoparticle and said Raman-active molecule, wherein the metal is Raman enhancing, and wherein said particle has a measurable SERS spectrum.

The tag may is applied by various methods, including application from an absorbent pad, sprayed from an atomizer, dispensed with a pen, an electrophotographic printing machine, an ink jet printing machine, offset lithography, letterpress, gravure, heliogravure, xerography, photography, silk-screening, a system for imagewise deposition of discrete quantities of a marking material on a substrate surface, film deposition system; or textile printing system.

In some embodiments, the tag may be applied to the document in ink. Inks include, but are not limited to flexographic ink, lithographic ink, silkscreen ink, gravure ink, bleeding ink, coin reactive ink, erasable ink, pen reactive ink, heat reactive ink, visible infrared ink, optically variable ink, penetrating ink. photochromic ink, solvent/chemical reactive ink, thermochromic ink, and water fugitive ink.

The document may be any document, not limited to paper documents, including, but not limited to stock certificates, airline tickets, baggage claim tickets, checks, negotiable instruments, commercial paper, passports, green cards, legal documents, wills, deeds of property, contracts, trusts, leases, assignments, easements, currency, postal documents, stamps, bonds, I.D. cards, birth certificates, driver's licenses, shipping invoices, adhesive labels, medical forms, medical histories, prescriptions, original works of art, valuable stamps, bank documents, credit cards, credit card authorizations, invoices, notes, permits, authorizations, applications, and tax returns.

The method may comprise a further step wherein the authenticity of the original document is verified by obtaining the SERS spectrum of the tag on the document.

The SENSER tag is stable once applied to the document. In some embodiments, the SENSER tag is stable for at least two months after being applied to the document.

The present invention also provides a method for detecting a counterfeit document, comprising scanning a document having security data encoded thereon in machine-readable form, wherein said security data comprises at least one SERS spectrum, said SERS spectrum being read from a tag, said tag comprising a metal nanoparticle, a Raman-active molecule associated with the surface of the metal nanoparticle, and an encapsulant surrounding said metal nanoparticle and said Raman-active molecule, wherein the metal is Raman enhancing; and comparing said scanned security data with pre-stored security data corresponding to said document, whereby a counterfeit document is detected.

In some embodiments, the further comprises determining whether the pre-stored security data matches the scanned security data and generating a validation message if the comparison is true, or determining whether the pre-stored security data matches the scanned security data and generating an invalidation message if the comparison is false.

An apparatus for detecting a counterfeit document, comprising means for scanning a document having security data encoded thereon in machine-readable form, wherein said security data comprises a SERS spectrum, said SERS spectrum being read from a tag, said tag comprising a metal nanoparticle, wherein the metal is Raman enhancing, a Raman-active molecule associated with the surface of the metal nanoparticle, and an encapsulant surrounding said metal nanoparticle and said Raman-active molecule.

The apparatus, in some embodiments, comprises means for comparing said scanned security data with pre-stored security data corresponding to said document. The apparatus may comprise means for determining the comparison is true and generating a validation message an/or means for determining the comparison is false and generating an invalidation message.

In some embodiments, the first and second communication means include means for sending and receiving data over a system selected from the group consisting of a telecommunications system, an analog telephone line, a digital telephone line, a cellular telephone system, and a computer data network.

The invention also provides a system for identifying a tag, wherein the tag comprises a Raman enhancing metal nanoparticle having a measurable SERS spectrum, a Raman-active molecule associated with the surface of the metal nanoparticle, and an encapsulant surrounding the metal nanoparticle and the Raman-active molecule, the system comprising a processor; a detector coupled to the processor and operable to detect a SERS spectrum of a tag to be identified; and a reference database coupled to the processor and comprising a list of possible components of the tag to be identified and a reference spectrum associated with each possible component; the processor being configured to execute instructions for receiving the detected spectrum from the detector; accessing the reference database; and generating a weighted linear combination of the spectra of the possible components which substantially corresponds to the detected spectrum whereby the components of the weighted linear combination substantially identify the tag to be identified.

In some embodiments, the instructions for generating a weighted linear combination comprise instructions for performing an ordinary least squares regression. In other embodiments, the processor is further configured to execute instructions for displaying through a user input/output interface the spectra of the possible components and the detected spectrum; and receiving through the user input/output interface user-entered regression parameters. In other embodiments, the the processor is further configured to execute instructions for applying a regression polynomial to model drift in the detector.

The present invention also provides a computer program product of a computer readable medium usable with a programmable computer, the computer program product having computer-readable code embodied therein for identifying a tag, wherein the tag comprises a Raman enhancing metal nanoparticle having a measurable SERS spectrum, a Raman-active molecule associated with the surface of the metal nanoparticle, and an encapsulant surrounding the metal nanoparticle and the Raman-active molecule, the computer-readable code comprising instructions for receiving a detected spectrum from a SERS detector, accessing a reference database comprising a list of possible components of a tag to be identified and a reference spectrum associated with each possible component; and generating a weighted linear combination of the spectra of the possible components which substantially corresponds to the detected spectrum whereby the components of the weighted linear combination substantially identify the tag to be identified.

In some embodiments, the instructions for generating a weighted linear combination comprise instructions for performing an ordinary least squares regression. In some embodiments, the computer-readable code further comprises instructions for displaying through a user input/output interface the spectra of the possible components and the detected spectrum; and receiving through the user input/output interface user-entered regression parameters. In some embodiments, further comprises instructions for applying a regression polynomial to model drift in the SERS detector.

### BRIEF DESCRIPTION OF THE FIGURES

FIG. 1 shows spectra of trans-1,2-dipyridylethylene (BPE) and 4,4′-dipyridyl (dipy) reporter SENSER tags in yellow and red inks collected using 647.1 nm excitation. 0.1 second integration was used to avoid saturating the CCD. From top to bottom BPE in yellow ink, dipyridyl in red ink, and dipyridyl in yellow ink.

FIG. 2 shows a spectrum of a BPE reporter SENSER tag on a dollar bill after the background has been subtracted.

FIG. 3 shows the spectra of tags and the background for tags applied to a polymer thread.

FIG. 4 shows the spectra of tags and the background for tags applied to a metal foil.

FIG. 5 shows a combination of a BPE (bis(pyridyl)ethylene) SENSER tag and a (2-quinlinethiol) (QSH) SENSER tag.

FIG. 6A shows an embodiment in which SENSER tag optical detection is accomplished by a simple, low cost CCD based spectrometer. FIG. 6B shows detection of SENSER tags in a note authentication and sorting application.

FIG. 7 shows peak finding data from a combination of QSH and BPE SENSER tags.

FIG. 8 shows quantification of several mixtures containing both QSH and BPE SENSER tags.

FIG. 9A shows BPE in yellow ink on paper using the Ocean Optics system and FIG. 9B shows BPE in yellow ink on paper using the JY Horiba system.

FIG. 10 shows block diagram of a computing system 800 on which the SENSERSee program may be implemented.

FIG. 11 shows a screen capture from SENSERSee program. The image was collected while the program was being used to analyze a sample containing both QSH and BPE SENSER tags.

FIG. 12A and B show replicate Raman spectra of three concentration levels of SENSER Tags in ink. 30% (light), 7.9% (dark) and 1.9% (medium). In FIG. 12A, the spectra are untreated. In FIG. 12B, the spectra have been normalized to give roughly equivalent baselines.

FIG. 13 shows the limit of detection for four different SENSER tags in yellow ink. From top to bottom, d⁸-dipyridyl, QSH, diprylidyl, and BPE.

FIG. 14 shows Raman spectra of four SENSER tags used to mark ink; from top to bottom d8-dipyridyl, QSH, BPE, dipyridyl. The baselines are offset for clarity.

FIG. 15 shows the detection limit for d⁸-dipyridyl SENSER tags in red ink.

FIG. 16 shows a small region of the Raman spectra from replicate samples of 60:40 (light) and 40:60 (dark) mixtures of BPE and d⁸-dipyridyl SENSER tags.

FIG. 17A and B show the mixture analysis data for BPE and d8-dipyridyl tags in red (FIG. 17A) and yellow (FIG. 17B) inks.

FIG. 18 shows spectra from d⁸-dipyridyl SENSER tags in yellow ink on white paper before (light) and after (dark) one month of aging.

### DETAILED DESCRIPTION OF THE INVENTION

The present invention describes the use of silica encapsulated nanoparticles for surface enhanced Raman scattering (SENSER) tags as covert taggants for documents, including paper documents, and documents made from other materials. These nanoparticles, referred to as SENSER™ tags, comprise a metal nanoparticle, in which the metal is Raman enhancing; a Raman-active molecule (sometimes referred to as a SERS tag or reporter molecule) attached to, or associated with the surface of the nanoparticle; and an encapsulant, usually SiO₂ (glass), surrounding the metal nanoparticle and the Raman-active molecule, and where the particle has a measurable SERS spectrum. Although the invention is described in terms of SENSER tags prepared from single nanoparticles, it is to be understood that nanoparticle core clusters or aggregates may be used in the preparation of SENSER tags. Methods for the preparation of clusters of aggregates of metal colloids are known to those skilled in the art. The use of sandwich-type particles as described in U.S. Pat. No. 6,861,263, is also contemplated.

The invention will be described primarily in the context of the detection of counterfeit currency, but all aspects of the invention are applicable also to other documents, such as stock certificates, airline tickets, baggage claim tickets, checks, negotiable instruments and other commercial paper, passports, green cards, legal documents such as wills, deeds of property, contracts, trusts, leases, assignments, and easements, currency, postal documents, stamps, bonds, I.D. cards, birth certificates, driver's licenses, shipping invoices, adhesive labels, medical forms, medical histories, prescriptions, original works of art, valuable stamps, bank documents, credit cards, credit card authorizations, invoices, notes, permits, authorizations, applications, and tax returns, and other governmental filings, among others. SENSER tags serve as detectable tags as described in Mulvaney, et al., “Glass-coated, analyte-tagged nanoparticles: A new tagging system based on detection with surface-enhanced Raman scattering”, Langmuir 2003, 19:4784-4790, U.S. Pat. No. 6,514,767, and U.S. patent application Ser. No. 11/113,601, entitled “Surface Enhanced Spectroscopy-Active Composite Nanoparticles,” filed Apr. 25, 2005. The text of Mulvaney, et al., U.S. Pat. No. 6,514,767, application Ser. No. 11/113,601 and all other patents and publications referred to herein, are incorporated by reference herein in their entirety. By adding the tags to the currency materials as a covert taggant, the currency can be determined to be counterfeit or not. It is also possible to use the covert taggant to encode additional information, such as the site of manufacture, the name of the manufacturer, and other useful characteristics. Currencies are made up from ink, paper and other materials such as thread, plastic and metals, and so the taggants should be compatible with these materials, and be detected when applied to these materials.

SERS data may be obtained from the tags using a suitable excitation wavelength. For example, in the case of the most reporter molecules excitation wavelengths in the range of about 600-1000 nm, including. In some embodiments, the excitation wavelengths are 632.8, 785, or 980 nm. Examples of reporters include 4-mercaptopyridine (4-MP); trans-4, 4′ bis(pyridyl)ethylene (BPE); quinolinethiol; 4,4′-dipyridyl, 1,4-phenyldiisocyanide; mercaptobenzamidazole; 4-cyanopyridine; 1′, 3,3,3′, 3′-hexamethylindotricarbocyanine iodide; 3,3′-diethyltiatricarbocyanine; malachite green isothiocyanate; bis-(pyridyl)acetylenes; Bodipy, and isotopes thereof, including, for example, deuterated BPE, deuterated 4,4′-dipyridyl, and deuterated bis-(pyridyl)acetylenes; as well as pyridine, pyridine-d5 (deuterated pyridine), and pyridine-¹⁵N. A suitable excitation wavelength is one at which the background noise component, generated by fluorescence from the document surface is low enough to obtain a detectable SERS signal.

The SENSER tags may comprise any nanoparticle core known in the art to be Raman-enhancing. As used herein, the term “nanoparticle”, “nanostructure”, “nanocrystal”, “nanotag,” and “nanocomponent” are used interchangeably to refer to a particle, generally a metallic particle, having one dimension in the range of about 1 nm to about 1000 nm, between 1 nm and 1000 nm. In some embodiments, the metal nanoparticle core is a spherical or nearly spherical particle of 20-200 nm in diameter. In some embodiments the range is about 20 nm to about 50 nm, in some embodiments in the range of about 30 nm to about 100 nm (for example about 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, or 100 nm). The tags may be polydisperse. That is, a group of tags may comprise tags with these ranges of diameters, but each tag need not have the same diameter.

Nanoparticles may be isotropic or anisotropic. Anisotropic nanoparticles may have a length and a width. In some embodiments, the length of an anisotropic nanoparticle is the dimension parallel to the aperture in which the nanoparticle was produced. In the case of anisotropic nanoparticles, in some embodiments, the nanoparticle has a diameter (width) of 350 nm or less. In other embodiments, the nanoparticle has a diameter of 250 nm or less and in some embodiments, a diameter of 100 nm or less. In some embodiments, the width is between 15 nm to 300 nm. In some embodiments, the nanoparticle has a length of about 10-350 nm.

Nanoparticles include colloidal metal, hollow or filled nanobars, magnetic, paramagnetic, conductive or insulating nanoparticles, synthetic particles, hydrogels (colloids or bars), and the like. The nanoparticles used in the present invention can exist as single nanoparticles, or as clusters or aggregates of the nanoparticles. Clusters or aggregates may be formed by the addition of aggregating agents to the SENSER tags.

It will be appreciated by one of ordinary skill in the art that nanoparticles can exist in a variety of shapes, including but not limited to spheroids, rods, disks, pyramids, cubes, cylinders, nanohelixes, nanosprings, nanorings, rod-shaped nanoparticles, arrow-shaped nanoparticles, teardrop-shaped nanoparticles, tetrapod-shaped nanoparticles, prism-shaped nanoparticles, and a plurality of other geometric and non-geometric shapes. Another class of nanoparticles that has been described include those with internal surface area. These include hollow particles and porous or semi-porous particles. Moreover, it is understood that methods to prepare particles of these shapes, and in certain cases to prepare SERS-active particles of these shapes, have been described in the literature. While it is recognized that particle shape and aspect ratio can affect the physical, optical, and electronic characteristics of nanoparticles, the specific shape, aspect ratio, or presence/absence of internal surface area does not bear on the qualification of a particle as a nanoparticle.

A nanoparticle also includes a nanoparticle in which the metal includes an additional component, such as in a core-shell particle. For example, Ag core/Au shell particles, like those described in J. Am. Chem. Soc. 2001, 123, 7961, or Au core/Ag shell particles, or any core-shell combination involving SERS-active metals, can be used. Other combinations suitable for use in core-shell particles are included in this invention, such as Au- or Ag-nanoparticle functionalized silica/alumina colloids, Au- or Ag- functionalized TiO₂ colloids, Au nanoparticle capped-Au nanoparticles (see, for example, Mucic, et al., J. Am. Chem. Soc. 1998, 120, 12674), Au nanoparticle-capped TiO₂ colloids, particles having and Si core with a metal shell (“nanoshells”), such as silver-capped SiO₂ colloids or gold-capped SiO₂ colloids. (See, e.g. Jackson, et al., 2004 Proc Natl Acad Sci USA. 101(52):17930-5; Talley, et al., Nano Letters (2005)). Hollow nanoparticles such as hollow nanospheres and hollow nanocrystals may also be utilized in the SENSER tags.

46Various systems can be used for detection of SENSER tags. A number of commercially available instruments may be used. For example, Raman Systems Inc., Enwave Optronics, Inc., Kaiser Optical Systems, Inc., InPhotonics, Inc., J-Y Horiba, Renishaw, Bruker Optics, Thermo Electron, Avalon, GE Ion Track, Delta Nu, Concurrent Analytical, Raman Systems, Inphotonics, Chemlmage, Jasco, Lambda Systems, SpectraCode, Savante, Real-Time Analyzers, Veeco, Witec, and other companies provide Raman spectrometers suitable for use in the present invention.

Example 2 describes experiments with two systems, one from Ocean Optics, Inc., and one from JY Horiba, that may be used in the present invention.

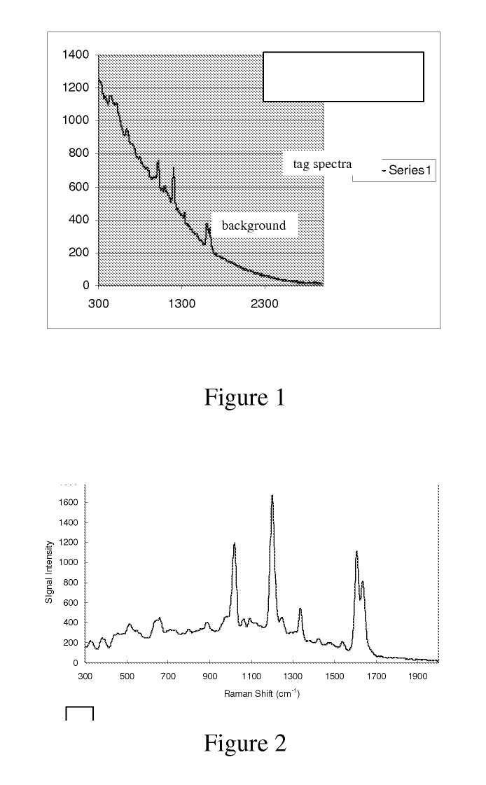

The SENSER tag may be associated with the document by covalent or noncovalent means. Any of a wide variety of suitable methods for associating the SENSER tag with the document can be employed. For example, the SENSER tag or composition may be maintained within an absorbent pad, sprayed from an atomizer, or dispensed with a pen. SENSER tags may be added to paper directly by absorption of the tag by the paper, FIG. 1. A background subtracted spectrum appears in FIG. 2. The SENSER tag or marking composition may be applied using any suitable means.

A SENSER tag may be added to a marking material, solid or liquid, and the resulting composition may be used in a printing or patterning method. In some embodiments, the SENSER tag or marking composition is applied with a printer or printing press. The SENSER tag is present in the marking composition in any amount effective for enabling detection and/or identification of a Raman spectrum of the Raman-active compound when the marking material on the item is irradiated with the appropriate radiation. Typically, the SENSER tag is present in the marking composition in amounts of from about 0.0001 to about 5 percent by weight, although percentages outside this range may be utilized. In some embodiments, the SENSER tag is present in the marking composition in amounts of from about 1 percent to 5 percent by weight. In some embodiments, the SENSER tag is present in the marking composition in amounts of from about 2 percent to 3 percent by weight. In some embodiments, the SENSER tag is present in the marking composition in amounts of about 2.2 percent by weight. It should be noted that the amount can be outside these ranges. In some embodiments, the marking material is ink, such as a flexographic, lithographic, gravure or silkscreen ink. Examples of inks include, but are not limited to AquaFlex™ RUR40865; AquaFlex™ RIB01721; AquaFlex™ RIY01720; Flexosol® RYR42521; Flexosol® RYB42354; Flexosol® RYY42540; Arrowstar Cyan; MP-170; and UV Screen Ink (1726). Other inks, including security inks, are described herein. The tags may also be applied in electrophotographic and ink jet printing machines and other systems including offset lithography, letterpress, gravure, heliogravure, xerography, photography, silk-screening systems, systems for imagewise deposition of discrete quantities of a marking material on a substrate surface, such as paint, chemical, and film deposition systems; and systems for integration of colorant materials in an exposed surface of a fibrous substrate, such as textile printing systems.

It should be noted that additional security features may be included or utlilized for a particular documents. One such additional security feature may be a security ink, such as bleeding ink, coin reactive ink, erasable ink, pen reactive ink, heat reactive ink, visible infrared ink, optically variable ink, penetrating ink. photochromic ink, solvent/chemical reactive ink, thermochromic ink, water fugitive ink. The SENSER tags may be applied as part of the ink, or in a separate step. Other non-ink based security features which may be utilized in addition to SENSER tags include the sue of an ascending serial number (horizontal and/or vertical format), bar code and numerals, colored fibers, embedded security thread, face-back optical registration design (transparent register), foil imprints, holograms, latent impressions, micro printing, optical variable devices (OVD), planchettes, raised marks, segmented security threads, and watermark.

The tags may be applied by coating an image, including but not limited to a hologram image, made with toner or ink compositions known in the art, as with an overcoat varnish, or a starch overcoat.

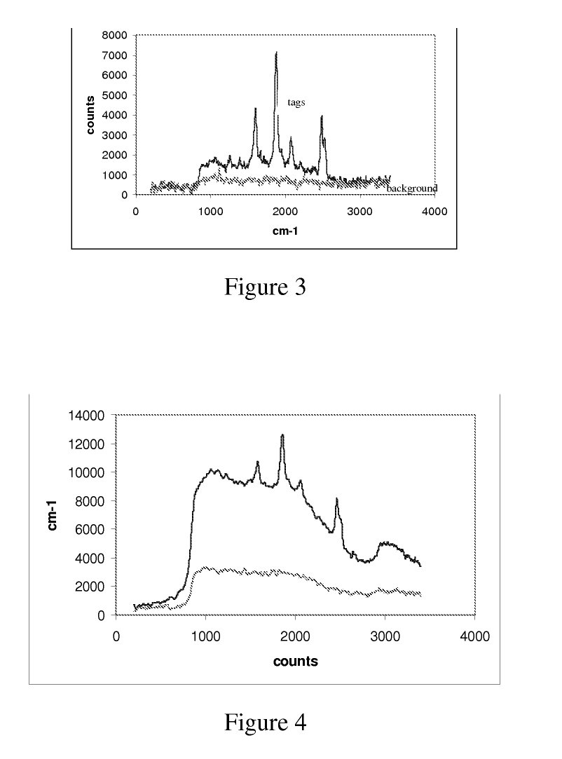

In the case of documents with other security features, such as those including polymer threads or metal foils, the tag may be applied to additional feature, such as the thread (FIG. 3) or the foil, (FIG. 4).

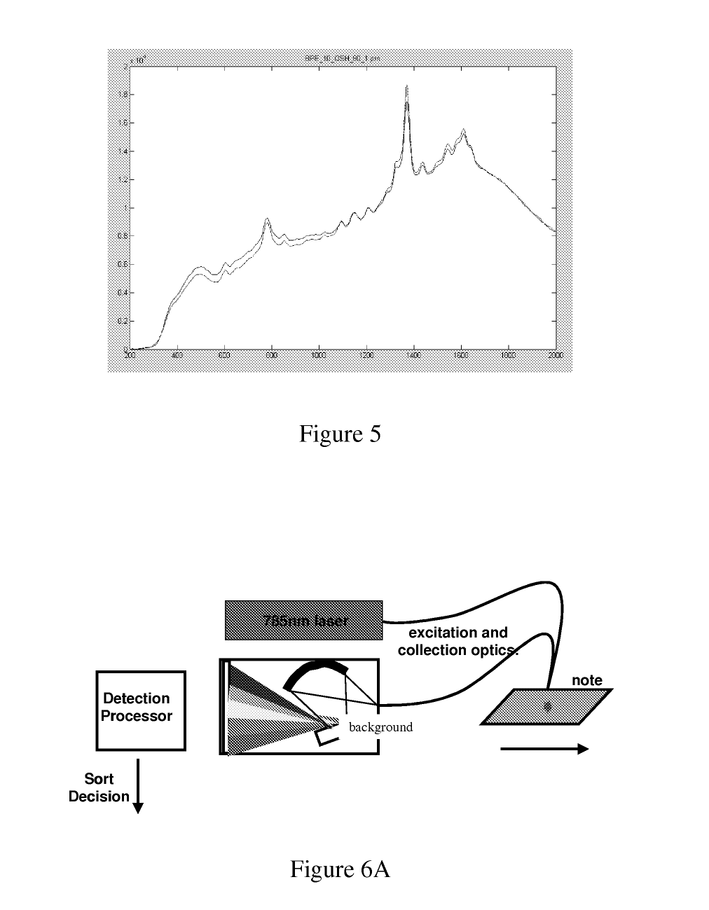

In one embodiment, single tags constitute an “alphabet” and groups of these single tags can be combined as “words” to create large numbers of spectral tags. Combinations of tags will produce unique spectra. FIG. 5 shows a combination of a BPE (bis(pyridyl)ethylene) SENSER tag and a QSH (2-quinlinethiol) SENSER tag. Thus, SENSER tags proved a large spectral codes space and will be difficult to counterfeit. If n is the number of tags available and k is the number of items chosen the number of combinations, C, is:

C=n!/(n-k)!k!

So if n=5 and k=2

C=15 combinations or words.

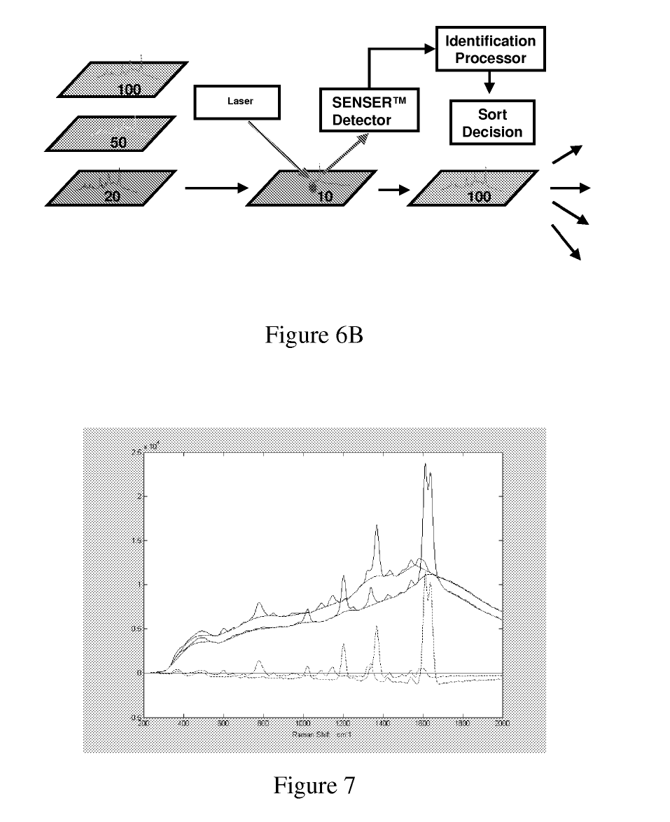

In some embodiments, the SENSER tags provide a very bright signal which means that they can be either added at very low concentrations and/or detected at high speed. High speed detection is important since currency counting and sorting machines also perform an authentication check. In one embodiment, an anti-counterfeiting taggant is be detected, identified and a sort decision rendered in a short period of time, i.e. up to as 100 notes per second. Accordingly, in one embodiment, the invention provides a system and method for detecting counterfeit currency wherein a currency bill encoded with security data is scanned by a currency scanning terminal. The security data includes the SERS spectrum of the SENSER tag associated with the bill. The currency scanning terminal reads the security data and transmits it via a communications link to a programmable security computer. The security computer responds to receipt of the security data by comparing the transmitted security data with previously stored security data and generating a comparison result. If the comparison result is true, a validation message is generated indicating that the currency is authentic and the currency is accepted. If the comparison result is false, a validation message is generated indicating that the currency is inauthentic, and the currency is rejected. For example, the SENSER tags can be read by a simple, low cost Raman spectrometer, FIG. 6A. A laser source is focused on the note to be interrogated with the collection optics, fiber optics or discrete optical components. Emitted SERS signal is collected by the emission optics, fiber optics or discrete optical components. The collected signal is sent to a grating spectrometer. The grating separates the collected light spatially by color. The color bands are detected by a discrete linear array of detectors, CCD, CMOS , PMTs or photodiodes. The detected spectrum is then sent to a microprocessor for analysis. The analysis decision engine optionally removes background and then compares the final spectra to the library of spectra possible. Once the decision is made the note's authenticity is determined, and the note is accepted or rejected. The accepted and rejected notes may be separated by a note sorter.

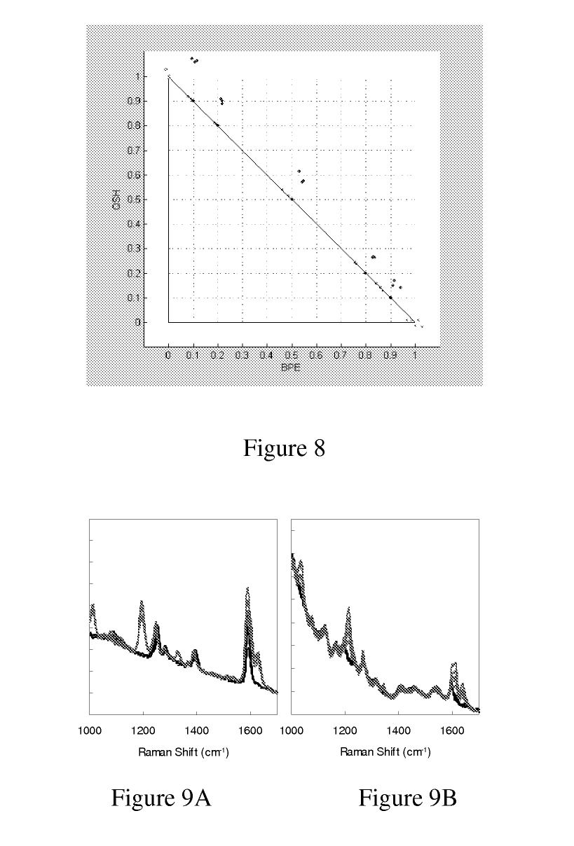

In a related embodiment, individual denominations of note contain spectrally distinct SENSER tags. The detector and processor can be used to generate the sort decision, as shown in FIG. 6B. The combined spectra may be identified directly by looking for peaks, FIG. 7. The components may be quantified and separated using least square fitting techniques. Example summary data for the quantification of relative amounts of BPE tag and QSH tag in a mixture appear in FIG. 8.

### EXAMPLES

The following examples are provided for illustrative purposes only and are not intended to limit the scope of the invention.

### Example 1

Tagging of Materials.

A spectrum of bispyridylethylene (BPE) labeled SERS nanotags deposited with a pipette onto a dollar bill is shown in FIG. 1. The starch overcoat on paper can be tagged, allowing documents to be tagged. SERS tags can be applied to foils and other materials, such as polymers. The SERS taggant is applied by first soaking the materials in 5% aminopropyl-trimethoxysilane (APTMS) in ethanol for 15 minutes. Next the materials were transferred to a solution of 4×10¹¹ #/mL BPE tags and soaked for 30 minutes. The materials were rinsed in ethanol. See FIG. 3 and FIG. 4.

### Example 2

Ocean Optics vs. JY-Horiba

SENSER tags were made with four different label molecules: bis-pyridylethylene (BPE), quinolinethiol (QSH), 4,4′-dipyridyl (dipy), and deuterated 4, 4′-dipyridyl (d8-dipy). Several experiments using 647. 1-nm excitation. BPE and dipyridyl tags were mixed into red and yellow inks and deposited on tan paper. In the best cases the acquired spectra show a broad fluorescent signal with a small Raman signal riding on the top. Samples were examined using both the free space optics associated with the JY-Horiba monochromator and the modular and relatively inexpensive Ocean Optics (OO) system. Using the OO components, spectra were collected with 1-second integration. Various systems can be used for detection of SENSER tags. For example, samples may be excited at 647.1 nm with a mixed gas Kr/Ar laser to provide up to 60 mWatt of power at the sample. After focusing through a 20×0.4 NA objective the scattered light was captured using the same objective, separated from the excitation beam using a dichroic mirror, and passed through a holographic notch filter to reduce the amount of Rayleigh scattering that reached the detector. The CCD format is 2048 pixels by 512 pixels. The CCD detector may be back illuminated for high quantum efficiency in the red and NIR regions. The back thinning process in this CCD also leads to a phenomenon called etaloning in the NIR region. Etaloning results in a spatial modulation of the detected spectra that can smear out weak spectral features. The analysis methods described herein can eliminate this regular and periodic artifact, but it will reduce sensitivity. The system can accommodate multiple collection optics, though most data was acquired with a 20×, 0.4NA Olympus microscope objective. Light collected by the objective passes through a 647.1 nm holographic notch filter and is focused onto the spectrometer slit with an 80 mm focal length lens. Although it is possible to extract data from these spectra, the large fluorescence background generates is responsible for a large noise component in the measurement and it is much easier to use 785-nm excitation as will be shown below. The very large fluorescence ends up contributing a large and variable noise component to the measurements.

The same general scheme may be used with a 500 mW, 785 nm diode laser source with the appropriate changes in dichroic filters and Rayleigh rejection notch filters. The second 785 nm system is an inexpensive Ocean Optics USB 2000 spectrometer. This detector is not cooled nor is it of scientific grade and so has considerably more electronic noise. The system uses optical fibers to couple light from the 160 mW, 785 nm laser manufactured by Ahura Inc., and a detection head manufactured by InPhotonics. The detection head uses a 0.4NA aspheric lens. The system slit width is fixed at 50 microns and provides spectral resolution of 6 cm-1.

TABLE 1
Features of Raman Detection Systems at Nanoplex

| | JY-Horiba | Ocean Optics |
|---|---|---|
| Laser Power | 500 mW, can be | 160 mW |
| (785 nm) | shuttered | |
| CCD | LN₂ cooled scientific | Room temperature, |
| | grade | inexpensive |
| Optics | Free space, 20×, 0.4 NA | Fiber optic coupled with |
| | objective, 100 μm slit | asphere for collection |
| Instrument | Etaloning of CCD can | High read and dark |
| Cons | obscure spectra | noise |
| Instrument | 25 ms detection | Clean spectra |
| Pros | demonstrated | |

While the higher power can clearly generate more intense SERS signals, for many samples with dark pigmentation the high powers induce burning. For example, blue, black, and green papers and inks may burn when exposed to long exposure (>1 sec) to the 785 nm sources in excess of 200 mWatts; therefore, these parameters should be monitored with new systems. Modification of exposure time and power level is well within the ability of one of ordinary skill in the art.

For the JY system the integration time was 0.2 seconds and 10 mWatt of 785-nm excitation was used. Spectra from identical replicate samples are shown in FIG. 9. For both systems the data has been adjusted to give comparable baselines, making visual comparison easier. It is clear that the background signals obtained using the two instruments are quite different. With the Ocean Optics components there is a gradually decreasing, but smooth, baseline with the background signal about 2× larger at 1000 cm-1 than at 1600 cm-1. The baseline is much more patterned with the JY system and the intensity increases by a factor of about 5. Since neither system has been white-balanced the difference in baseline intensity could be due to different efficiencies of gratings or detectors as a function of wavelength. The patterned background observed with the JY system is harder to explain but may well be due to etaloning of the back-thinned detector. Because the Ocean Optics system gave results that were at least comparable to those obtained using the much more cumbersome JY system, the vast majority of the quantitative work was carried out using the Ocean Optics system. It should be noted that for the JY system, factors such as CCD binning and long integration times do not give us great improvements. This is due to the fact that these measurements are not signal limited, but blank limited. Even at 785 nm the major source of noise in the measurements is the variation in the background fluorescence signal from either the paper or the ink.

### Example 3

Spectral Survey of Materials

Five types of ink were examined for handling and overall background signal evaluation in the Raman wavelength band of interest. All experimentation was performed with the Ocean Optics USB2000 spectrometer at two power settings (normal power and 15% of normal power).

Inks were obtained from two companies that do security printing as part of their businesses, Flex Products Inc., (Santa Rosa, Calf.) and Flint Ink (Flint, Mich.). The inks were flexographic, lithographic, and silkscreen inks. Handling varied between classes of ink and within classes. For instance, the Flint flexographic inks were subdivided into two classes—a water soluble type, trademarked AquaFlex™, and a solvent-based version, trademarked Flexosol®. These two types had different viscosities, background spectra, and dilution requirements. Overall, the semi-clear silk screen inks gave the optimal S/N compared to all inks examined. Among the flexographic inks, the yellow Flexosol® RYY and yellow AquaFlex™ RIY, gave the best S/N as these inks were able to tolerate standard incident 785 nm laser power.

In general handling varied considerably between inks. The AquaFlex™ and silkscreen inks were “easier” to handle mainly based on viscosity (pipettable) and limited dilution requirements. Both have very low viscosity. Combining complete water solubility with low viscosity makes suspending nanoparticles in the AquaFlex™ inks a facile procedure. Slightly more difficult to handle are the UV silkscreen inks which are soluble in methanol, among others (see Table 2). Methanol suspension of SENSER tags is achieved by spinning the water-suspended particles down for 5 minutes at 7000RPM followed by siphoning off the supernatant and adding an adequate aliquot of methanol. The Flexosol® inks could not be pipetted based on their high viscosity and instead must be aliquotted based on weight rather than volume (i.e. using a pipette). The most difficult to handle among all inks listed in Table 2, was the Flint Arrowstar Sheetfed lithographic ink. This ink is oil-soluble and has a molasses consistency making both metering out accurate proportions and suspension of nanoparticles difficult, as SENSER tags are normally suspended in water and they tend to be charged and thus hydrophilic. Dilution of the ink in a water-soluble solvent and/or addition of charged species to neutralize the tags would improve handling.

Background signal analysis was performed on the flexographic and silkscreen inks at two power settings: full laser power at 785 nm on the Ocean Optics USB2000 and 15% power. Only the yellow inks (Flint RIY and RYY) and silkscreen inks (Flex MP-170 and UV1726) can tolerate the full laser power. Background measurements on the RIB, RUR, RYR and RYB needed to be performed at 15% power to prevent ignition of the ink due to their high absorption. In general these inks were not examined further since such low laser powers were required and S/N with the BPE SENSER tag was quite low. Nonetheless, some background measurements were made. With respect to the AquaFlex™ inks, a very low background (˜10 counts at 15% laser power) was observed in the red RUR ink compared to an average 50-70 counts for the blue (RIB) and yellow (RIY) ink. With respect to the Flexosol® inks, red RYR unlike its red RUR counterpart, had a very high background intensity peaked toward low wavenumbers. Typically, this is characteristic of fluorescence background. The blue (RYB) Flexosol® ink had moderate background (30-50 counts) and the yellow (RYY) ink had the lowest background fluorescence.

### Example 4

BPE Signal Analysis

Despite the fact that we observed a lower background in the AquaFlex red ink, we did not observe any BPE tag SERS peaks at 25% 10X BPE in ink (v/v%). However, at the same doping level we observed quantifiable amounts of BPE in the blue (RIB) and yellow (RIY) AquaFlex inks. Indeed, the blue (RIB) ink gave almost 1.5X more peak intensity than the yellow. However, these S/N levels are very low (S/N ˜2-5) and these experiments were performed at 15% laser power. So, while the blue RIB ink might have a slightly larger S/N than RIY at this power level, it is preferable to operate at full laser power with RIY, which can therefore achieve much greater signal-to-noise ratios.

With respect to measuring BPE SERS peaks in the Flexosol inks at 15% laser power, we did not observe any BPE peaks at 100uL 10X BPE in 0.4 grams of ink. Therefore, we moved on to focus on the yellow (RIY, RYY) inks at full laser power.

The semi-clear UV silkscreen inks were tested with 10% 10X BPE (v/v%) at low (15%) laser power. BPE SERS peaks were readily observed with MP-170 outperforming UV Screen Ink 1726 by about 2X peak intensity. Nonetheless, operating at this low laser power is not optimal for overall signal-to-noise level. Screen inks have a small niche in the printing industry and most of our testing, therefore, focused on the yellow lithographic ink as it is representative of Nanoplex's capabilities in the broader printing field.

### Example 5

Development Of Software for Data Analysis

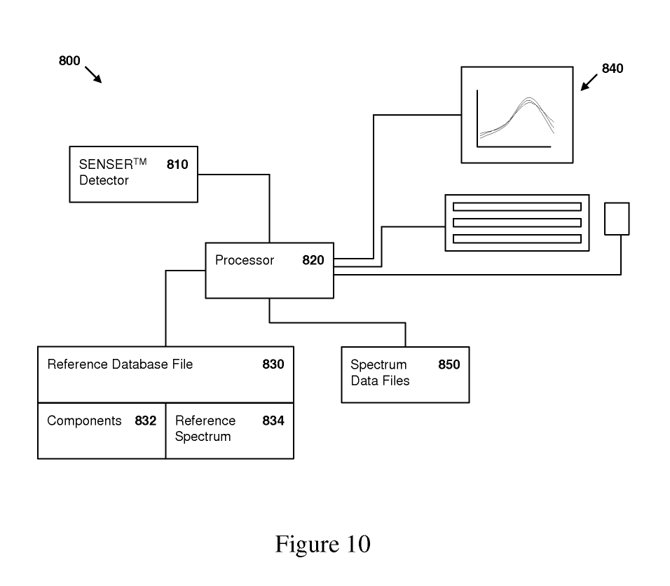

Algorithms were developed for tag identification in order to demonstrate the feasibility of automated tag identification. SENSERSee is a program for mixture analysis of Raman spectra. FIG. 10 is a block diagram of a computing system 800 on which the SENSERSee program may be implemented. The system 800 includes a device for detecting SENSER tags, such as a SERS SENSER™ spectrometer (detector) 810 as described hereinabove, a processor 820 for executing programmed instructions, a reference database file 830 for storing reference spectrum data, and a user input/output interface 840. The system may also include storage for previously obtained spectrum data files 850. The spectrum to be analyzed—an unknown spectrum from a tag to be identified- may come directly from the spectrometer 810, or from a computer file 850. The file formats currently supported are Galactic SPC, Ocean Optics scope, and plain text XY-pairs although the scope of the present invention is not limited to any particular file format. In addition to the unknown spectrum, SENSERSee requires a list of components 832 and a reference spectrum for each 834 in the reference database file 830. The reference spectra are stored in files, but they may be preprocessed in any way desired, e.g. by averaging, filtering, etc. A component can be either a SENSER taggant, or a background (paper, glass, nitrocellulose, etc.).

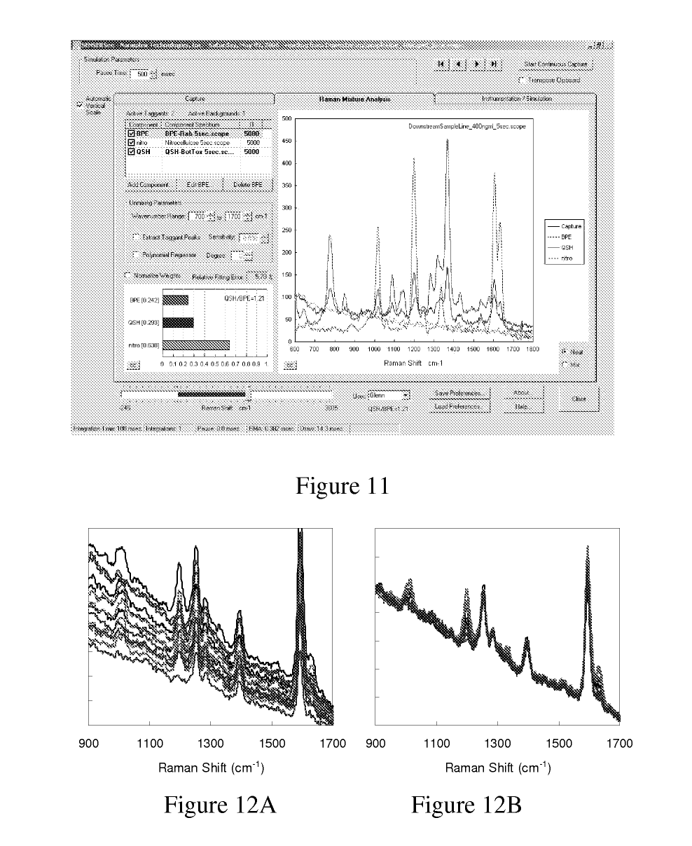

The processor 820, executing SENSERSee instructions, computes a weight for each component, so that the weighted linear combination of the component spectra is as close as possible to the unknown spectrum, in the least-squares sense. In other words, it performs an ordinary least squares (OLS) regression. All spectra are displayed for the user through the user interface 840, including the weighted linear combination and the relative least-squares error. Also through the user interface 840, the user has control of the range of wavenumbers used in the regression, and has the option of automatic peak extraction. The user also has the option of directing the processor 820 to use a polynomial in the regression to model spectrometer drift. The program was written in Microsoft Visual Basic, except for the numerical regression module, which was written in C++; however, the present invention is not dependent upon or limited to any particular programming language or operating environment. FIG. 11 is a screen capture of the program as it looks for QSH and BPE tags in a mixture containing both. This program has made the generation of quantitative data from our mixtures as well as limit of detection data much easier and can serve as the basis for a more extensive package for sample analysis.

### Example 6

Quantitative Measurements of Tags—Limits of Detection

To determine the limits of detection, the tag particles were first concentrated to 20× of standard by centrifugation. Samples were prepared by mixing the tags with known amounts of ink. Inks were obtained from Flint, Inc. For this study inks designated RIY01720 (yellow) and RYR42521 (red) were used. The masses of tag, ink and water (used to compensate when smaller amounts of tag were added) were determined on an analytical balance. Table 3 shows the amounts of components used.

TABLE 3
Components used to create detection limits
mixtures (all values in grams).

| | | | |
|---|---|---|---|
| tag | ink | H₂O | % |

BPE

| | | | |
|---|---|---|---|
| 0.1003 | 0.2338 | 0.0000 | 30.0 |
| 0.0505 | 0.2309 | 0.0502 | 15.2 |
| 0.0257 | 0.2232 | 0.0751 | 7.9 |
| 0.0110 | 0.2273 | 0.0890 | 3.4 |
| 0.0061 | 0.2275 | 0.0946 | 1.9 |

Yellow ink
d8 dipyridyl

| | | | |
|---|---|---|---|
| 0.0993 | 0.2198 | 0.0000 | 31.1 |
| 0.0496 | 0.2291 | 0.0494 | 15.1 |
| 0.0243 | 0.2328 | 0.0747 | 7.3 |
| 0.0104 | 0.2313 | 0.0893 | 3.1 |
| 0.0054 | 0.2407 | 0.0939 | 1.6 |

dipyridyl

| | | | |
|---|---|---|---|
| 0.0996 | 0.2230 | 0.0000 | 30.9 |
| 0.0497 | 0.2394 | 0.0495 | 14.7 |
| 0.0247 | 0.2269 | 0.0740 | 7.6 |
| 0.0102 | 0.2232 | 0.0888 | 3.2 |
| 0.0052 | 0.2374 | 0.0937 | 1.5 |

QSH

| | | | |
|---|---|---|---|
| 0.0995 | 0.2314 | 0.0000 | 30.1 |
| 0.0502 | 0.2281 | 0.0502 | 15.3 |
| 0.0253 | 0.2402 | 0.0746 | 7.4 |
| 0.0102 | 0.2350 | 0.0893 | 3.0 |
| 0.0057 | 0.2265 | 0.0946 | 1.7 |

Red ink
d8 dipyridyl

| | | | |
|---|---|---|---|
| 0.1003 | 0.2503 | 0.0000 | 28.6 |
| 0.0502 | 0.2377 | 0.0500 | 14.9 |
| 0.0248 | 0.2575 | 0.0749 | 6.9 |
| 0.0104 | 0.2703 | 0.0896 | 2.8 |
| 0.0056 | 0.2701 | 0.0950 | 1.5 |

No tag

| | ink | H₂O |
|---|---|---|
| Yellow | 0.2400 | 0.1000 |
| red | 0.2716 | 0.1002 |

To prepare the paper samples two microliters of each mixture was drawn into a micropipette and deposited on the paper. An 8-path scraper was used to draw the ink across the substrate. Five replicates were made of each sample.

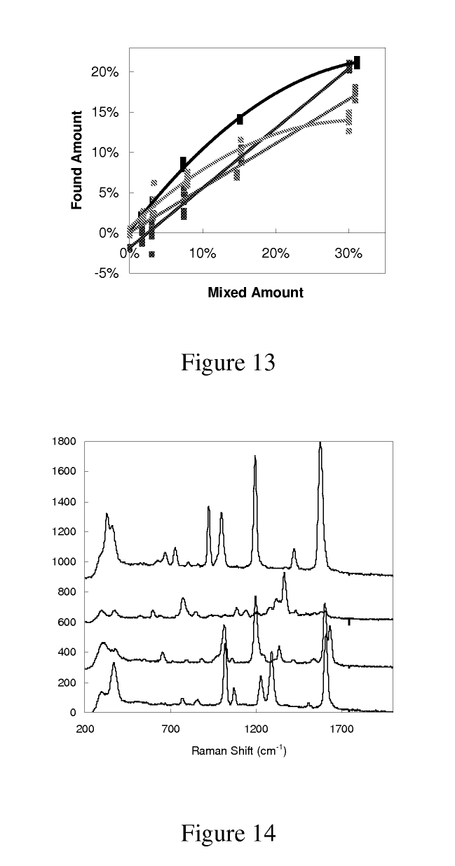

Replicate spectra for three of the BPE concentration levels are shown in FIG. 12. In FIG. 12A are the spectra for 30%, 7.9% and 1.9% (all percentages are mass of nanotags solution/total mass) samples as they are collected by the spectrometer. FIG. 12B are the same spectra after scaling to an approximately equivalent baseline measurement. By adjusting the spectra to constant baseline it is easier to see the differences between the samples. The BPE contributions to the spectra are seen mostly clearly at 1020 cm⁻¹, 1200 cm⁻¹, and 1630 cm⁻¹, while the ink peaks at 1255 cm⁻¹ and 1400 cm⁻¹ are generally unchanged. To quantitate each of the tags, the SENSERSee software was set up to look for the tag of interest using a measurement of the paper and a measurement of ink on paper as background components. In addition, a 3rd order polynomial was used to account for broad background fluctuations. The other three tags were not used as components in this analysis. Once quantities of tags are calculated they can be used to construct calibration curves and determine limits of detection. The composite plot for all four species is shown in FIG. 13. The x-axis is the percent of 20× tag by weight in the final mixture, while the y-axis is the amount found by the software. Note that the y axes for the four tags are not truly comparable because the value found by the software depends strongly on the intensity of the “standard” spectrum used for that component.

On an empirical basis we can use these results to calculate detection limits. If we use the definition of detectable signal as being three standard deviations (standard deviation of the blank) above the average blank measurement, then values of 4.8%, 0.33% and 0.34% are calculated as the limits of detection for BPE, QSH, dipyridyl, and d8-dipyridyl tags respectively. This is consistent as the Raman spectra of the tags in solution show that the largest signal comes from the d8-dipyridyl followed by BPE and dipyridyl, which are similar and QSH, which gives the smallest signal. (FIG. 14)

Using the approximation that both the tag solution and the tagged inks have densities approaching 1 g/1 mL, a 1% solution of tag in tagged ink contains 10 μL of tagging solution per 1 mL of tagged ink. The tagging solutions have 8×10¹¹ tag particles per mL. Therefore, the 1% solution of tag in ink contains 8×10⁹ particles/mL. Since all printing samples were made with 2 μL of tag in ink, 1.6×10⁷ particles were used per sample. Although it varied considerably from sample to sample, the area that can be printed with 2 μL of ink can be estimated to be 1 cm². Thus, under the conditions used here, a 1% solution is equivalent to a particle density of 0.16 particles/micron². Table 4 summarizes the detection limits for the tags studied.

TABLE 4
Detection Limits for Tags in yellow and red ink

| Sample | % detected | Particles/micron² |
|---|---|---|
| QSH in yellow ink | 4.8% | 0.76 |
| BPE in yellow ink | 0.33% | 0.053 |
| dipy in yellow ink | 0.34% | 0.054 |
| d⁸ - dipy in yellow ink | 0.17% | 0.027 |
| d⁸ - dipy in red ink | 2.2% | 0.35 |

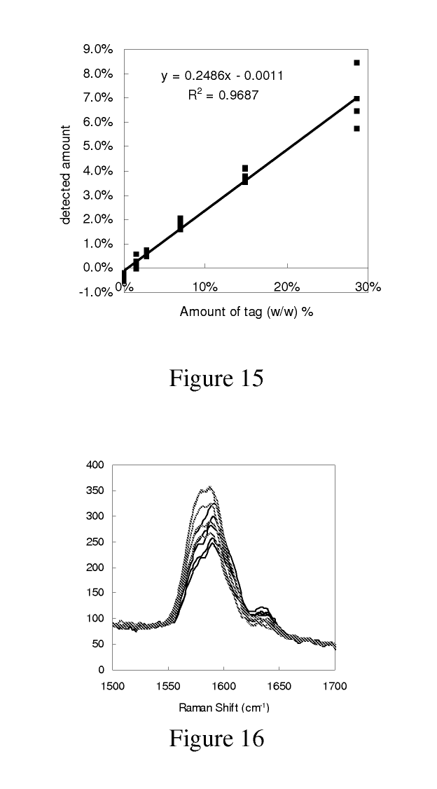

For samples in red ink the amount of power was reduced to the point where the samples did not burn. This was still generally >100 mWatt with the Ocean Optics components. As with the yellow inks, a calibration curve was established using the d8-dipy tags in red ink. The curve is shown in FIG. 15. From this data a detection limit of 2.2% (w/w) was calculated, approximately one order of magnitude higher than the same tag in yellow ink.

### Example 7

Measurement of Tag Uniqueness

In many cases the important measurement task will be to determine which of many possible tags are present on an item. For this purpose, the spectra acquired above were reanalyzed against a least-square basis set that included spectra for all four tags as well as the ink and paper backgrounds and the 3rd order polynomial. The software was configured such that negative coefficients were not possible for the tags, however negative coefficients were allowed for the background components. Using the simple criterion that the component with the largest detected coeffiecient is called, all samples are correctly identified except for three of the 5% and one 10% QSH sample, which are all miscalled as 4,4′-dipyridyl. Again, the QSH tag has the smallest signal of the tags used for this study, so it is not particularly surprise that samples may be misidentified at the lowest concentrations of QSH.

### Example 8

Mixture Analysis

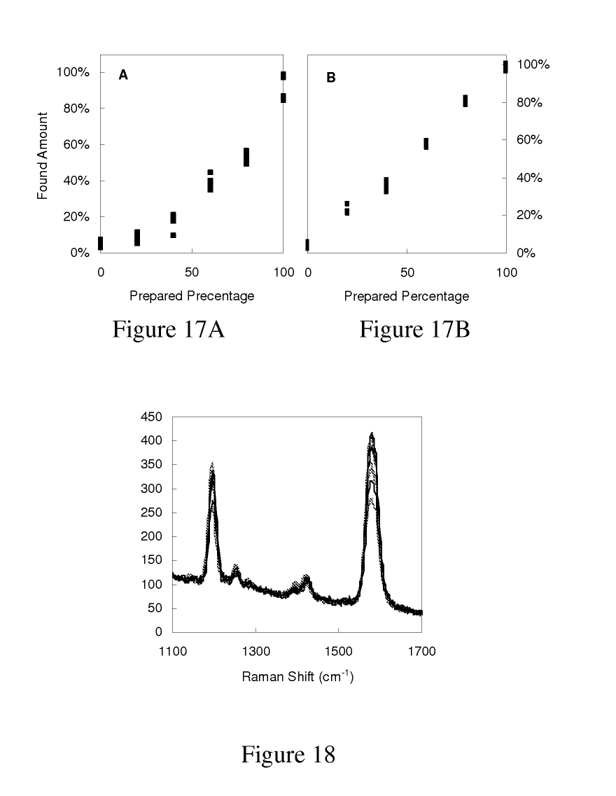

A series of tag mixtures were prepared by combining 20x BPE and 20x d8-dipyryidyl tags in 80:20, 60:40, 40:60, and 20:80 ratios, to make 100 μL of each mixture. Approximately 250 μL of either yellow or red ink was then added to each sample. For the 100% d8-dipy samples fresh preparations were made, for the 100% BPE samples the data from previously prepared 100% BPE samples was reanalyzed. FIG. 16 shows one region from the spectra of five replicates each of the 60:40 BPE to d8-dipy (red) and 40:60 BPE to d8dipy (black) samples in yellow ink on tan paper. As can be seen, relatively subtle differences in the spectra are responsible for the measurable changes detected by our analysis program. FIG. 17A and B show the found amount of tag versus the amount originally put in the mixture for the 30 samples run (5 replicates at 6 concentrations). As can be seen from the plot the 20% ratio steps are large enough to produce distinct clusters of data points with the yellow ink. The ratios of signals are less unique in the red ink where the signals from the 0%, 20%, and 40% BPE/d8 mixtures are too closely clustered. This is due to the fact that the reduced laser power makes it more difficult to clearly distinguish the less intense signal (in this case the BPE) from the background. Ratios of SERS nanotags can be used as unique codes for authentication as long as the false positive/false negative rates are aceeptable, and as long as the tag brightness and the ultimate sensitivity system are acceptable. These measurements are well within the ability of one of ordinary skill in the art.

### Example 9

Stability

To provide preliminary data on the stability of SERS nanotags in print surfaces we remeasured the spectra from all four types of tagged samples one month after the initial measurements. Spectra of five, d8 replicates before (red) and after (black) one month are shown in FIG. 18. After adjusting the baseline the spectra are quite similar and no systematic change in signal is seen. The limits of detection (calculated by the same method as before) were 0.34% (d8-dipy), 0.79% (BPE), 0.98% (dipy) and 4.9% (QSH) quite similar to the previously calculated values.

TABLE 2

| | | | Specific | | | |
|---|---|---|---|---|---|---|
| Manufacturer | Ink Label | Description | Gravity | Soluble In | Handling Suggestions | Signal Observations |
| Flint | AquaFlex | RED | 1.045 | Water: best Not | Almost pipetable - | Vaporize at normal laser |
| | RUR40865 | | | ethanol: congeals | lose˜100-200 uL when | intensity. When decrease |
| | | | | Acetone: alters | pipetting 1000 ul in | power to 15% of normal, low |
| | | | | consistency slightly | 1 ml tip | (10 cts) bgnd compared to |
| | | | | | | RIB/RIY. |
| Flint | AquaFlex | BLUE | 1.031 | Water: best Not | Almost pipetable - | Vaporize at normal laser |
| | RIB01721 | | | ethanol (congeals) | lose˜100-200 uL when | intensity. When decrease |
| | | | | Acetone: alters | pipetting 1000 ul in | power to 15% of normal, |
| | | | | consistency slightly | 1 ml tip | medium (50-70 cts) bgnd |
| | | | | | | compared to RUR. Lots of |
| | | | | | | peaks at low power. Slightly |
| | | | | | | better performer with BPE at |
| | | | | | | low (15%) laser power than RIY. |
| Flint | AquaFlex | YELLOW | 1.003 | Water: best Not | Almost pipetable - | Only AquaFlex ink not |
| | RIY01720 | | | ethanol (congeals) | lose˜100-200 uL when | damaged at normal laser power. |
| | | | | Acetone: alters | pipetting 1000 ul in | When decrease power to 15% |
| | | | | consistency slightly | 1 ml tip | of normal, medium (50-70 cts) |
| | | | | | | bgnd compared to RUR. Lots of |
| | | | | | | peaks at low power. Better |
| | | | | | | performer with BPE tags at |
| | | | | | | full power. |
| Flint | Flexosol | RED | 0.948 | Not water | Not pipettable. Use | Vaporizes at normal laser |
| | RYR42521 | | | Acetone | mass with scale in | intensity. Very high |
| | | | | Ethanol: best | Corning Cell Culture | fluorescence (peaked toward |
| | | | | | Dishes (PS) | low wavenumber) background |
| | | | | | Cat#430166 | (100-150 counts) at 15% power. |
| Flint | Flexosol | BLUE | 0.893 | Not water | Not pipettable. Use | Vaporizes at normal laser |
| | RYB42354 | | | Acetone | mass with scale in | intensity. Medium (30-50 cts) |
| | | | | Ethanol: best | Corning Cell Culture | background at low 15% laser |
| | | | | | Dishes (PS) | power. Observed many peaks |
| | | | | | Cat#430166 | in spectra. |
| Flint | Flexosol | YELLOW | 0.940 | Not water | Not pipettable. Use | Only Flexosol ink not damaged |
| | RYY42540 | | | Acetone | mass with scale in | at normal laser power. Low |
| | | | | Ethanol: best | Corning Cell Culture | background yet difficult to |
| | | | | | Dishes (PS) | observe taggants at hi doping level. |
| | | | | | Cat#430166 | |
| Flint | Arrowstar | BLUE | ??? | Vegetable Oil | Very thick. Need scale | Flame-out when placed on |
| | Cyan | | | | and cell culter dishes. | paper alone at full power |
| | | | | | | (Ocean Optics Spec.) |
| Flex | MP-170 | CLEAR | ??? | Not water | Not pipettable. Use | No damage at normal laser |
| | | | | Methanol: good | mass with scale in | powers. Very low background |
| | | | | Acetone: good | Corning Cell Culture | in ink on paper. BPE peaks |
| | | | | Ethanol: good | Dishes (PS) | readily observed at 10% by |
| | | | | | Cat#430166 | volume doping of 10× BPE. |
| Flex | UV Screen | YELLOWISH | ??? | Not water | Not pipettable. Use | No damage at normal laser |
| | Ink (1726) | CLEAR | | Methanol: good | mass with scale in | powers. Very low background |
| | | | | Acetone: good | Corning Cell Culture | in ink on paper. BPE peaks |
| | | | | Not Ethanol: | Dishes (PS) | readily observed at 10% by |
| | | | | congeals | Cat#430166 | volume doping of 10× BPE. |

What is claimed is:

1. A method for providing a security feature for documents, the method comprising:
a) providing a document to be protected;
b) applying at least one tag to at least a first portion of the document, wherein said tag comprises a metal nanoparticle, a Raman-active molecule associated with the surface of the metal nanoparticle, and an encapsulant surrounding said metal nanoparticle and said Raman-active molecule, wherein the metal is Raman enhancing, and wherein said particle has a measurable SERS spectrum.

2. The method of claim 1, wherein the tag may is applied via a method selected from the group consisting of application from an absorbent pad, sprayed from an atomizer, dispensed with a pen, an electrophotographic printing machine, an ink jet printing machine, offset lithography, letterpress, gravure, heliogravure, xerography, photography, silk-screening, a system for imagewise deposition of discrete quantities of a marking material on a substrate surface, film deposition system; and textile printing system.

3. The method of claim 1, wherein the tag is applied to the document in ink.

4. The method of claim 3, wherein the ink is selected from the group consisting of flexographic ink, lithographic ink, silkscreen ink, gravure ink, bleeding ink, coin reactive ink, erasable ink, pen reactive ink, heat reactive ink, visible infrared ink, optically variable ink, penetrating ink. photochromic ink, solvent/chemical reactive ink, thermochromic ink, and water fugitive ink.

5. The method of claim 1, wherein the document is selected from the group consisting of stock certificates, airline tickets, baggage claim tickets, checks, negotiable instruments, commercial paper, passports, green cards, legal documents, wills, deeds of property, contracts, trusts, leases, assignments, easements, currency, postal documents, stamps, bonds, I.D. cards, birth certificates, driver's licenses, shipping invoices, adhesive labels, medical forms, medical histories, prescriptions, original works of art, valuable stamps, bank documents, credit cards, credit card authorizations, invoices, notes, permits, authorizations, applications, and tax returns.

6. The method of claim 1, wherein the authenticity of the original document is verified by obtaining the SERS spectrum of the tag on the document.

7. The method of claim 1, wherein the security feature is stable for at least two months after being applied to the document.

8. A method for detecting a counterfeit document, comprising:
a) scanning a document having security data encoded thereon in machine-readable form, wherein said security data comprises at least one SERS spectrum, said SERS spectrum being read from a tag, said tag comprising a metal nanoparticle, a Raman-active molecule associated with the surface of the metal nanoparticle, and an encapsulant surrounding said metal nanoparticle and said Raman-active molecule, wherein the metal is Raman enhancing; and
b) comparing said scanned security data with pre-stored security data corresponding to said document, whereby a counterfeit document is detected.

9. The method of claim 8, further comprising determining whether the pre-stored security data matches the scanned security data and generating a validation message if the comparison is true.

10. The method of claim 8, further comprising determining whether the pre-stored security data matches the scanned security data and generating an invalidation message if the comparison is false.

11. An apparatus for detecting a counterfeit document, comprising
means for scanning a document having security data encoded thereon in machine-readable form, wherein said security data comprises a SERS spectrum, said SERS spectrum being read from a tag, said tag comprising a metal nanoparticle, wherein the metal is Raman enhancing, a Raman-active molecule associated with the surface of the metal nanoparticle, and an encapsulant surrounding said metal nanoparticle and said Raman-active molecule.

12. The apparatus of claim 11, further comprising means for comparing said scanned security data with pre-stored security data corresponding to said document.

13. The apparatus of claim 12, further comprising means for determining the comparison is true and generating a validation message.

14. The apparatus of claim 12, further comprising means for determining the comparison is false and generating an invalidation message.

15. A system in accordance with claim 12 wherein said first and second communication means include means for sending and receiving data over a system selected from the group consisting of a telecommunications system, an analog telephone line, a digital telephone line, a cellular telephone system, and a computer data network.

16. A system for identifying a tag, wherein the tag comprises a Raman enhancing metal nanoparticle having a measurable SERS spectrum, a Raman-active molecule associated with the surface of the metal nanoparticle, and an encapsulant surrounding the metal nanoparticle and the Raman-active molecule, the system comprising:
a processor;
a detector coupled to the processor and operable to detect a SERS spectrum of a tag to be identified; and
a reference database coupled to the processor and comprising a list of possible components of the tag to be identified and a reference spectrum associated with each possible component;
the processor being configured to execute instructions for:
receiving the detected spectrum from the detector;
accessing the reference database; and
generating a weighted linear combination of the spectra of the possible components which substantially corresponds to the detected spectrum whereby the components of the weighted linear combination substantially identify the tag to be identified.

17. The system of claim 16, wherein the instructions for generating a weighted linear combination comprise instructions for performing an ordinary least squares regression.

18. The system of claim 16, wherein the processor is further configured to execute instructions for:
displaying through a user input/output interface the spectra of the possible components and the detected spectrum; and
receiving through the user input/output interface user-entered regression parameters.

19. The system of claim 16, wherein the processor is further configured to execute instructions for applying a regression polynomial to model drift in the detector.

20. A computer program product of a computer readable medium usable with a programmable computer, the computer program product having computer-readable code embodied therein for identifying a tag, wherein the tag comprises a Raman enhancing metal nanoparticle having a measurable SERS spectrum, a Raman-active molecule associated with the surface of the metal nanoparticle, and an encapsulant surrounding the metal nanoparticle and the Raman-active molecule, the computer-readable code comprising instructions for:
receiving a detected spectrum from a SERS detector
accessing a reference database comprising a list of possible components of a tag to be identified and a reference spectrum associated with each possible component; and
generating a weighted linear combination of the spectra of the possible components which substantially corresponds to the detected spectrum whereby the components of the weighted linear combination substantially identify the tag to be identified.

21. The computer program product of claim 20, wherein the instructions for generating a weighted linear combination comprise instructions for performing an ordinary least squares regression.

22. The computer program product of claim 20, wherein the computer-readable code further comprises instructions for:
displaying through a user input/output interface the spectra of the possible components and the detected spectrum; and
receiving through the user input/output interface user-entered regression parameters.

23. The computer program product of claim 20, further comprising instructions for applying a regression polynomial to model drift in the SERS detector.
